(19) United States
(12) Patent Application Publication
(10) Pub. No.: US 2014/0195663 A1
(43) Pub. Date: Jul. 10, 2014

(54) Method and System for Providing Cloud-Based Common Distribution Applications

(71) Applicant: SIRIUS XM CONNECTED VEHICLE SERVICES INC., IRVING, TX (US)

(72) Inventors: Frank Hirschenberger, Highland Village, TX (US); Scott Nelson, Dallas, TX (US); James Dawson, Oceanside, CA (US); Michael Becker, Schwetzingen (DE)

(73) Assignee: SIRIUS XM CONNECTED VEHICLE SERVICES INC., IRVING, TX (US)

(21) Appl. No.: 14/148,506

(22) Filed: Jan. 6, 2014

Related U.S. Application Data
(60) Provisional application No. 61/749,549, filed on Jan. 7, 2013.
(60) Provisional application No. 61/788,896, filed on Mar. 15, 2013.

(51) Int. Cl. H04L 12/24

(52) U.S. Cl. CPC H04L 41/20
USPC 709/223

(57) ABSTRACT

A system for providing cloud-based common distribution applications includes one or more devices. Each device is capable of being a different device type and having different parameters. The system includes a distributed common application package for deployment and/or updating in the cloud such that the common application package installs and runs on any of the devices independent of parameters of any of the devices. The distributed common application package includes common cloud mark-up language (ML) application code, common on-board ML application code, and/or common cloud logic application code. The system has an application distribution module and an application cloud runtime engine that is used to execute at least one application on the devices.

### CROSS-REFERENCE TO RELATED APPLICATIONS

This application claims priority to U.S. Provisional Application Ser. No. 61/749,549, filed on Jan. 7, 2013), and U.S. Provisional Application Ser. No. 61/788,896, filed on Mar. 15, 2013), the entire disclosures of which are hereby incorporated herein by reference in their entireties.

### STATEMENT REGARDING FEDERALLY SPONSORED RESEARCH OR DEVELOPMENT

Not Applicable

### FIELD OF THE INVENTION

The present invention lies in the field of cloud-based applications. The present disclosure relates to a method and system for providing cloud-based common distributed applications.

### BACKGROUND OF THE INVENTION

For delivering and executing applications on any device in the automotive and mobile domains, the typical approach in the industry is to create a monolithic (i.e., often native) application for each target device type. In addition, that monolithic application typically connects directly to any required content sources or cloud resources.

The basic problems that are created by this approach are as follows:
1) each device type (operating system, processor, control set, etc.) needs a specific application version for each device;
2) if there are changes in the content sources or cloud resources, the application has to change to accommodate those changes; and
3) all the application logic burden is in one place (typically the device application), so any and all changes are forced to occur here.

When the monolithic application is on the device, in order to change or update that application, a complete re-compile and re-validation of the application is required, often at great expense in terms of time and cost. Thus, a need exists to overcome the problems with the prior art systems, designs, and processes as discussed above.

### SUMMARY OF THE INVENTION

The invention provides applications that overcome the hereinafore-mentioned disadvantages of the heretofore-known devices and methods of this general type and that provide such features with cloud-based common distribution applications.

With the foregoing and other objects in view, there is provided, in accordance with the invention, a system for providing cloud-based common distribution applications. The system includes one or more devices. Each device is capable of being a different device type and having different parameters. The system includes a distributed common application package for at least one of deployment and updating in the cloud such that the common application package installs and runs on any of the one or more devices independent of parameters of any of the devices. The distributed common application package includes at least one of: common cloud mark-up language (ML) application code; common on-board ML application code; and common cloud logic application code. The system has an application distribution module and an application cloud runtime engine that is used to execute at least one application on the one or more devices.

In accordance with another feature of the invention, there is provided a cloud application manager that manages the distributed common application package.

In accordance with a further feature of the invention, the application distribution module identifies where applications need to go and sends a manifest deployment request into a specific service for performing the deployment.

In accordance with an added feature of the invention, the application cloud runtime engine uses common cloud markup language (ML) code and common cloud logic.

In accordance with an additional feature of the invention, the common cloud ML code comprises actual application code for a particular application.

In accordance with yet another feature of the invention, the common cloud logic is application-specific service logic that is loaded and run in the cloud.

In accordance with yet a further feature of the invention, personalization by customer is provided within the common application package.

In accordance with yet an added feature of the invention, an application line-up comprises a plurality of common application packages.

In accordance with yet an additional feature of the invention, the application line-up is customizable by customer.

In accordance with again another feature of the invention, dependence on an operating system and a processor is substantially eliminated using markup language and web-based technologies.

In accordance with again a further feature of the invention, the at least one application: runs in a browser or rendering engine; is installed on top of the operating system and the processor; and is non-native to the operating system.

In accordance with again an added feature of the invention, the web-based technologies include at least one of hypertext markup language, cascading style sheets, and JavaScript.

In accordance with again an additional feature of the invention, the common application package further includes a common bridge definition file and the common bridge file defines common ways that the at least one application is expecting to communicate with the one or more devices.

In accordance with still another feature of the invention, the one or more devices includes a native bridge code module that translates specific access to resources to the common bridge definition.

In accordance with still a further feature of the invention, the common application package is incrementally updated without requiring a complete re-compile.

In accordance with still an added feature of the invention, there is provided a cloud interfaces bridge and common cloud resources. The cloud interfaces bridge and the common cloud resources interface with the application cloud runtime engine to execute the at least one application.

In accordance with still an additional feature of the invention, at least one of the cloud interfaces bridge and the common cloud resources interfaces to external content and services.

In accordance with another feature of the invention, one or more of the common cloud ML application code, the common on-board ML application code, and the common cloud logic application code are accessed and changed.

In accordance with a further feature of the invention, the common on-board ML application code is device side application code.

In accordance with a concomitant feature of the invention, the common application package is distributed over the air.

Although the invention is illustrated and described herein as embodied in a system for providing cloud-based common distribution applications, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a diagrammatic illustration of an exemplary embodiment of a connected services model;

FIG. 2 is a diagrammatic representation of historical emergence of in-vehicle applications;

FIG. 3 is a diagrammatic representation of challenges facing connected applications;

FIG. 4 is a diagrammatic representation of ideals for connected applications;

FIG. 5 is an exemplary embodiment of a list of system axioms for connected applications;

FIG. 6 is a diagrammatic representation of an exemplary embodiment of axioms for connected applications;

FIG. 7 is a diagrammatic representation of an exemplary embodiment of a platform for providing applications in the cloud;

FIG. 8 is a diagrammatic representation of an exemplary embodiment of a platform approach for providing cloud-based applications;

FIG. 9 is a high-level block diagram of an exemplary embodiment of systems and methods for providing cloud-based applications;

FIG. 10 is a block diagram of an exemplary embodiment of a system for providing cloud-based applications and an application manager;

FIG. 11 is a diagrammatic representation of an exemplary embodiment of matching challenges and ideals with axioms for providing cloud-based services; and

FIG. 12 is a block diagram of an exemplary embodiment of a system for providing cloud-based applications.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

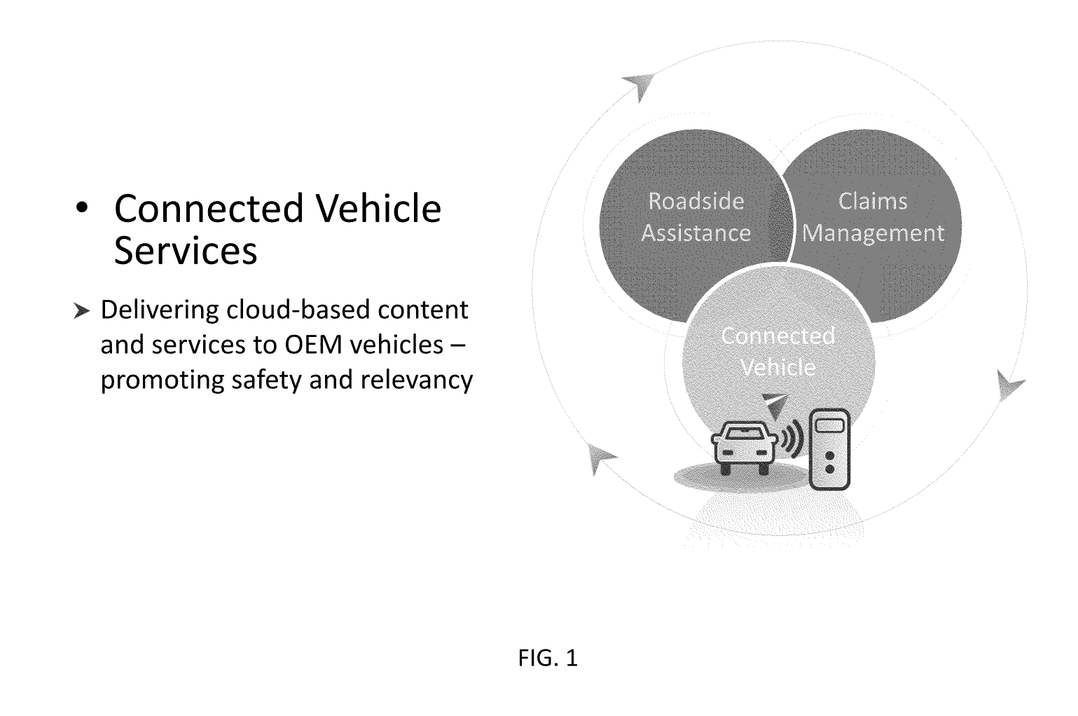

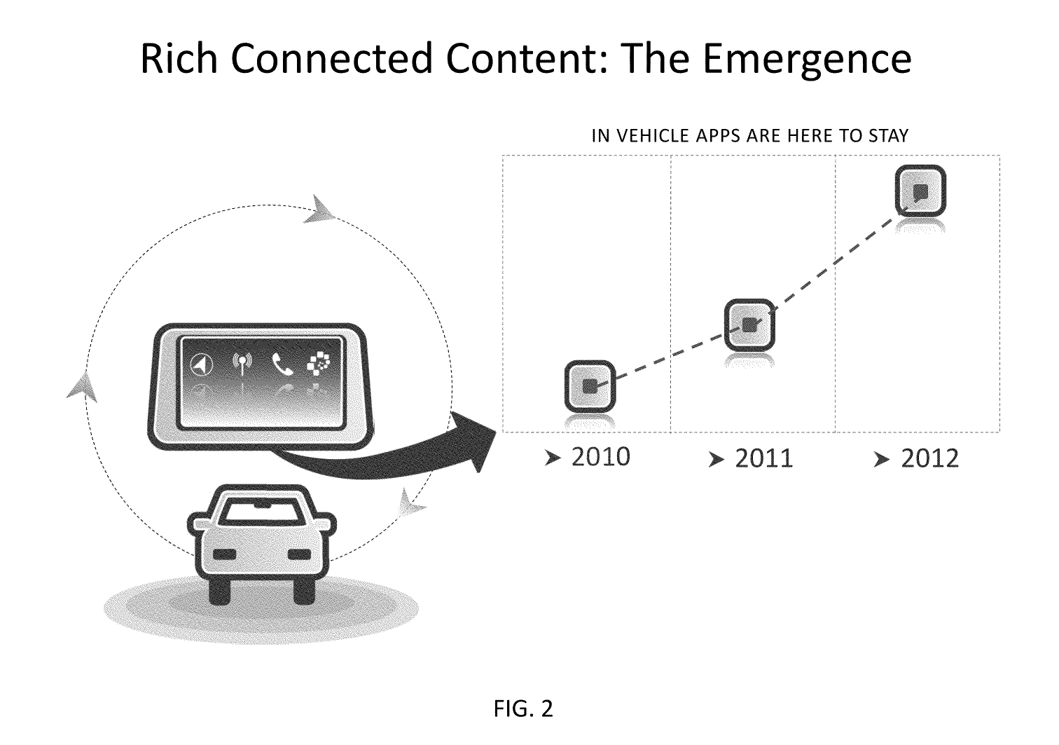

Described now are exemplary embodiments of the present invention. Referring now to the figures of the drawings in detail and first, particularly to FIG. 1, there is shown a first exemplary embodiment of a connected services model. In this model, the vehicle along with a mobile communications device can be connected to the cloud to deliver and receive content and/or services. FIG. 2 is a diagrammatic representation of an emergence of in-vehicle applications. In vehicle applications are shown as increasing exponentially over the past few years.

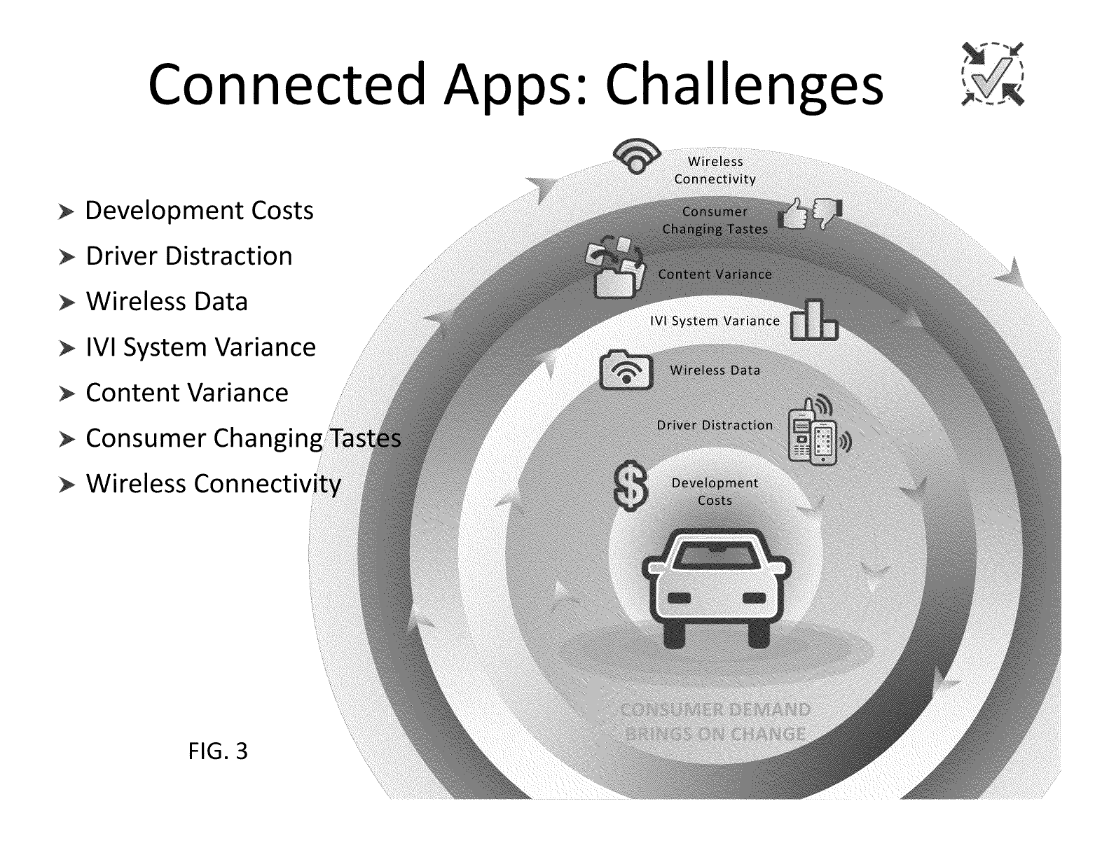

FIG. 3 is a diagrammatic representation of challenges facing connected applications. Some of these challenges are based on consumers' demand bringing on changes that include development costs, driver distraction, wireless data, in-vehicle infotainment (IVI) system variance, content variance, consumers changing tastes, and wireless connectivity.

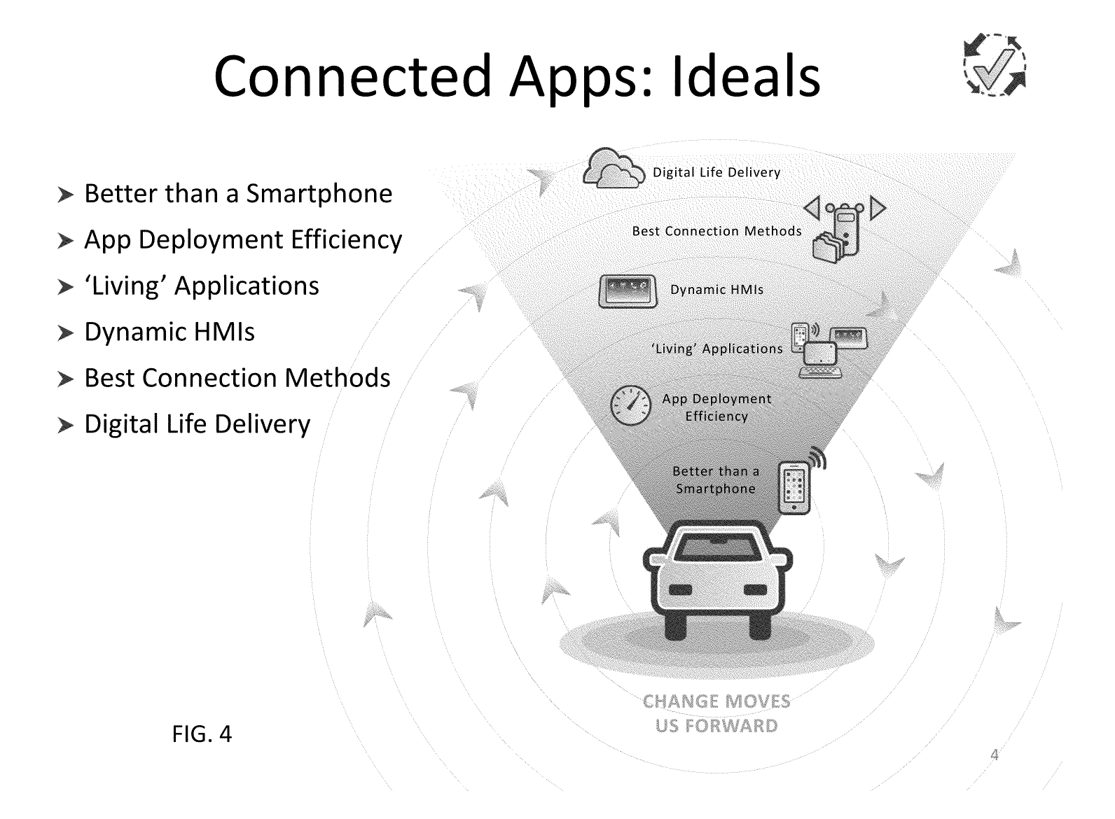

FIG. 4 is a diagrammatic representation illustrating ideals for connected applications. Connected applications are improved over a smartphone because they are, for example, device independent. The application deployment is more efficient. As the applications are based in the cloud, they are living and update globally. Dynamic human-machine interfaces (HMIs) are made possible. The best connection methods are available. Finally, there is provided digital life delivery.

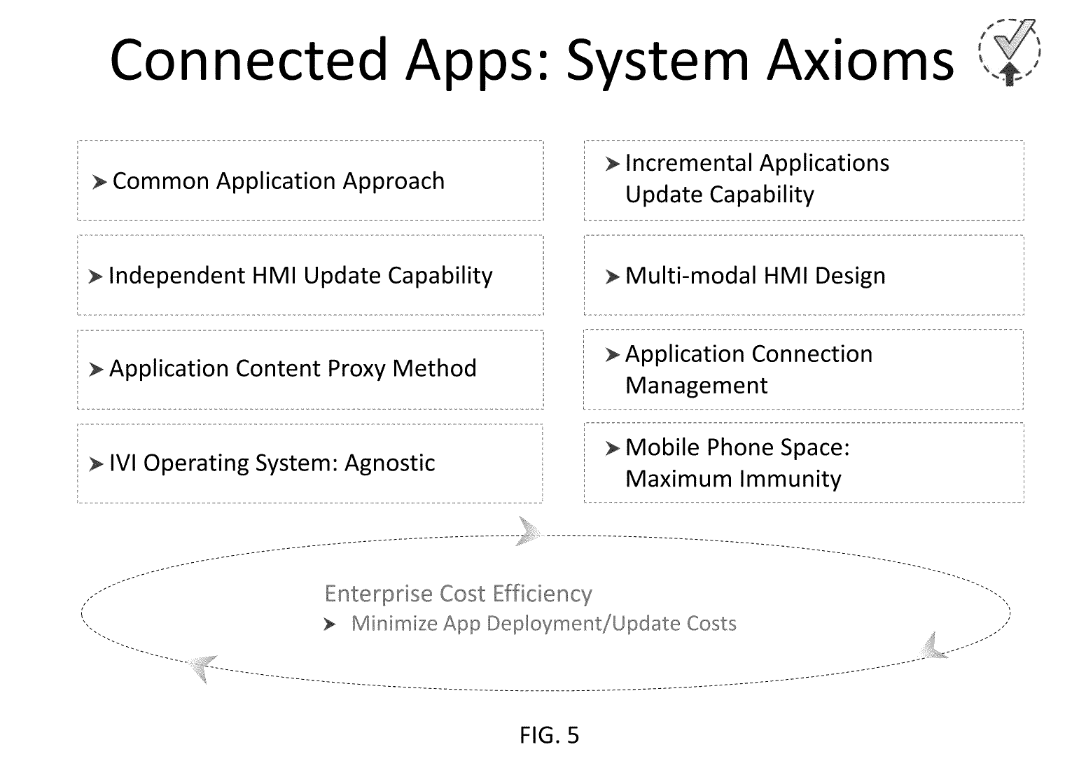

FIG. 5 is a block diagram illustrating system axioms for connected applications. The connected applications allow for a common application approach, provide independent HMI update capability, use the application content proxy method, allow the IVI operating system to be agnostic, permit incremental application update capability, have a multi-modal HMI design, provide application connection management, and have maximum immunity in the mobile phone space. Because of the efficiency in the enterprise cost of connected applications, minimization of application deployment and an update in costs occur.

One or more axioms are applicable to the present system. These axioms include: a common application approach; an incremental applications update capability; an independent HMI update capability; a multi-modal HMI design; an application content proxy method; application connection management; an IVI operating system agnostic; and maximum immunity within the mobile phone space.

Using a common application approach, one application works on all IVI systems. With an incremental applications update capability approach, an application can be updated without a complete re-compile, re-test, and re-download.

The independent HMI update capability allows for the updating of a HMI operation without changing any business logic. The multi-modal HMI design axiom provides the ability to fuse touch, voice, haptic, gesture, and multiple displays for an optimized safe experience.

An application content proxy method provides an in-cloud proxy between content and an application to insulate the application, provide useful in-cloud logic, and provide mash-up (of content, for example) in the cloud. Application connection management allows for independence of applications from the connectivity method. This independence provides an application with the ability to utilize a multiple internet protocol (multi-IP) connection manager.

An IVI operating system agnostic provides an ability to implement applications across multiple embedded operating systems. The maximum immunity axiom provides a system where there is no impact to service delivery as mobile phone operating systems (OS) and devices change.

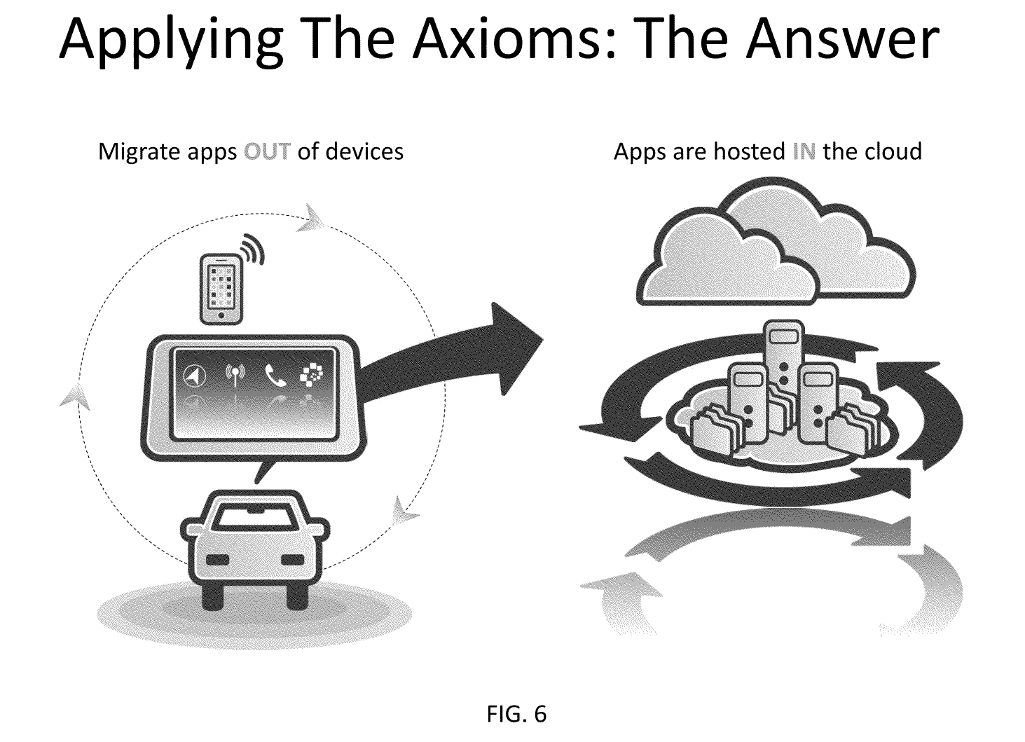

FIG. 6 is an exemplary embodiment of a diagram illustrating axioms for connected applications. In particular, the axiom is to migrate the applications out of the individual devices of the vehicle or the mobile platform and to have them hosted in the cloud.

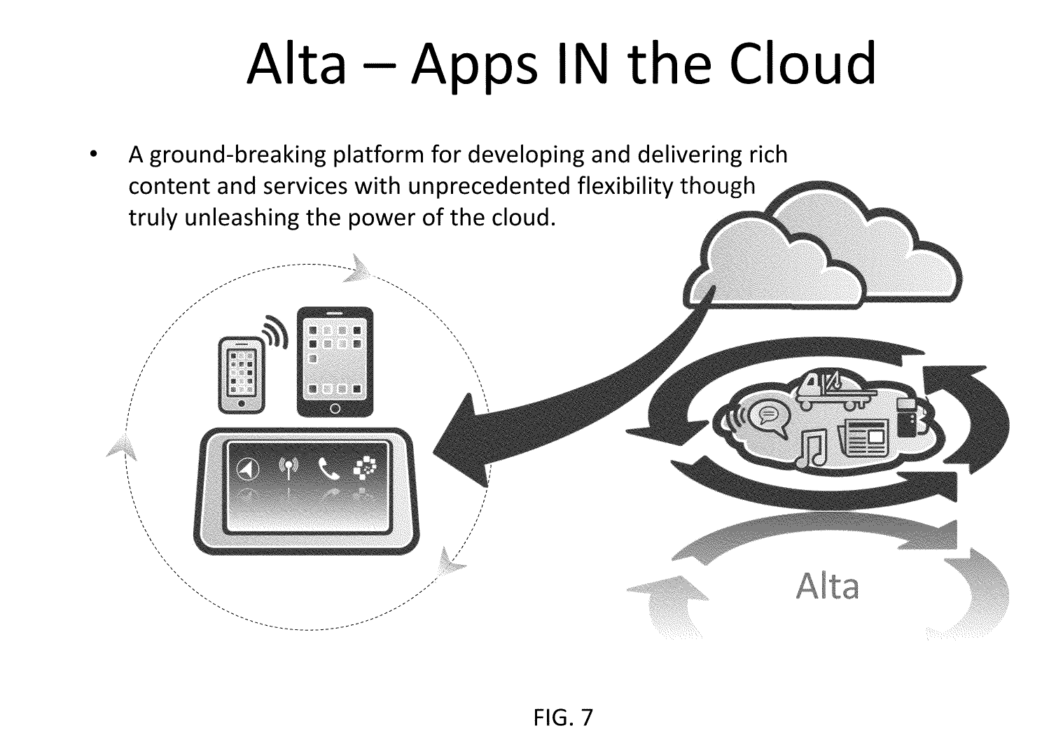

FIG. 7 is an exemplary embodiment of a platform for providing applications in the cloud. The platform allows for development and delivery of rich content and services with flexibility that allows direct application of the extreme power of the cloud.

The term “rich” in this context refers to a coupling of providing connected vehicle content along with integrated HMI controlled from the cloud. The rich content and services are enabled by very capable interfaces on-board in unison with off-board interfaces. The HMI components are enabled to be multi-modal, e.g., voice, hard/soft controls, gesture, multi-display, etc.

Some example popular rich content and services, e.g., in the form of integrated HMI and/or applications, well-suited for the present system are:
Internet radio (which, in one embodiment, can be integrated with an on-board satellite radio tuner);
Navigation (which, in one embodiment, can be integrated with variable location-based services or be part of an on-board navigation core);
Location-based services (examples of which include, but are not limited to, traffic, traffic cameras, red light cameras, couponing, movie listings, parking, electric vehicle charging, friends/family locator, and weather);
Point of interest (POI) based services (examples of which include, but are not limited to POI search, restaurant ratings/reservations, and hotel ratings/reservations);
Assistant services (examples of which include, but are not limited to, profile/business intelligence-based POI search and routing, personal calendar and task-driven routing, and multi-modal routing (e.g., vehicle, vehicle sharing, flights, trains, busses));
Infotainment (examples of which include, but are not limited to, sports, scores, stock data, and news);
Social networking, e.g., filtered incoming posts and messages, and outbound multi-modal posting;
Usage-based insurance; and
Diagnostics, e.g., vehicle diagnostics, and dealer messaging.

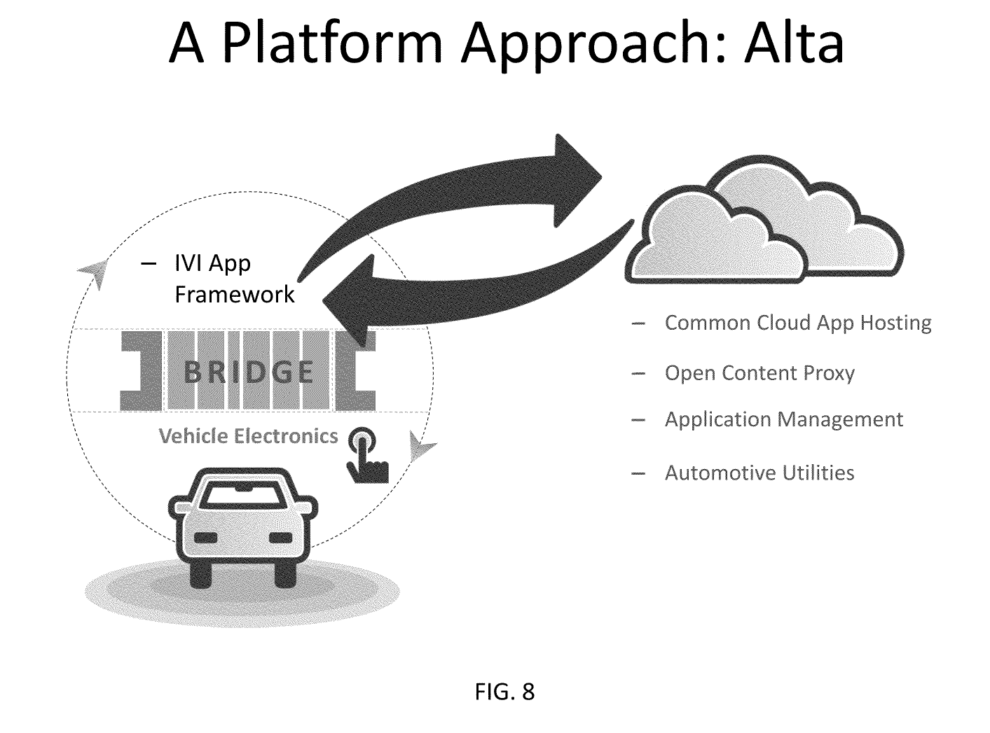

FIG. 8 is an exemplary embodiment of a diagram of a platform approach for providing cloud-based applications. In particular, the platform provides a bridge from the vehicle's electronics to the cloud using the IVI application framework. By doing this, beneficial characteristics arise, such as common cloud application hosting, open content proxy, application management, and automotive utilities.

With respect to “common cloud application hosting,” the system focus on the ‘common application’ is key. The benefit of the common application is that the common application is created by the application developer and will run on a variety of IVI systems. The “application hosting” refers the basic presence of the application in a place where it can be accessed and used. The application hosting can be on-board application code, off-board application code, and off-board application-specific service development and/or content proxy/mash-up (in any combination). The benefit of this is that a developer may want to develop in each of these methods and is not limited to developing in just one area of the platform (as many systems do).

With respect to the “open content proxy” characteristic, the content proxy is the concept that the applications come to a common cloud for their content, as opposed to reaching out to various content sites. This is especially beneficial in the case where the application code is on-board for security reasons. An application that is allowed to only reach out to one server (URL) is inherently much more secure than one that is allowed to reach out to multiple sites (as those multiple sites could easily be malicious). In addition, the content proxy provides the beneficial opportunity for the content interfaces to be made more efficient for the application developer. As a simple example, if a content provider provides data in simple object access protocol (SOAP) format, converting that to a representational state transfer (REST) format for the application to consume is known in the industry to be more efficient and easier to maintain. As a final benefit, the content can be easily mashed up in the cloud to create unique interfaces. For example, if a location-based service application needs both weather data and POI data for any given location, the POI data and the weather data (including, potentially, weather on the route, for example) can be sent in the same message as opposed to two separate calls.

“Application management” refers to the beneficial ability to manage application objects throughout the application lifecycle process. A system is required to enable: developers to post applications; administrators to approve those applications; product planners to enable those applications to be available based upon various parameters (IVI system, trim line, vehicle make/model/year); and a management system to make those application objects available in a user-consumable form (e.g., an application on an IVI system, an application on a phone/tablet, an application available on an application store front, etc.).

“Automotive utilities” refer to utilities that are made available to the application developer that are specifically designed for automotive use cases. For example, an automotive utility may be a social network posting service that is available to all applications developed on the platform that then utilizes profile data to appropriately create a post that uses context to have postings take place without distracting the driver. Another example of automotive utility may be off-board voice transcription/dictation that has context-specific language models along with automotive-tuned acoustic models to increase recognition accuracy.

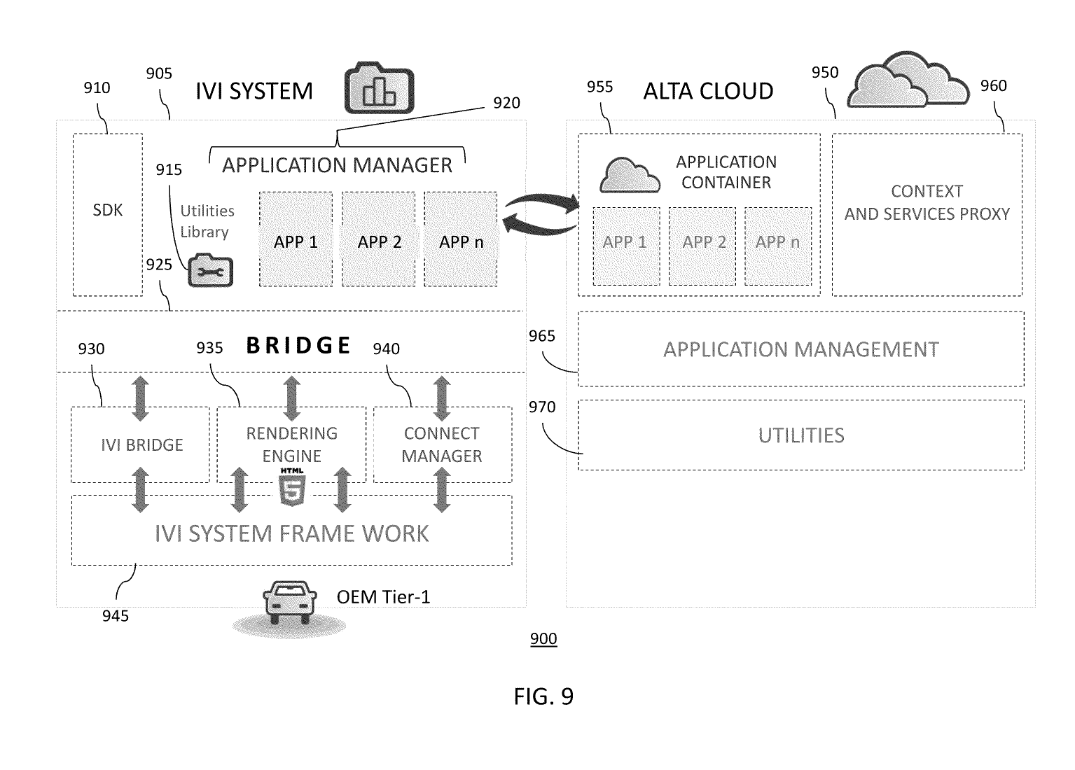

FIG. 9 is an exemplary embodiment of a high-level block diagram 900 for providing cloud-based applications. The high-level block diagram 900 includes an IVI system 905 and a cloud-based service 950. The IVI system 905 includes a software development kit (SDK) 910. An SDK 910 is a set of software development tools that allow for the creation of applications. In the present context, the SDK 910 provides tools for running cloud-based applications. The SDK specifies the core interfaces required for the IVI system 905 to interface with the Alta cloud, e.g., cloud-based service 950. The core interfaces include, but are not limited to device notification interfaces, application management interfaces, and any underlying security thereof. The interfaces may be in the form of reference code, code libraries, and/or specifications. IVI system 905 includes a utilities library 915 and an application manager 920. The application manager 920 is provided to manage a plurality of applications (APP 1, APP 2, . . . , APP n). IVI system 905 includes a bridge 925 that provides access to WI bridge 930, rendering engine 935, and connection manager 940. Modules 930, 935, 940 work within IVI system framework 945 to implement the plurality of applications managed by the application manager 920.

The cloud-based service 950 includes an application container 955 that stores the plurality of applications (APP 1, APP 2, APP n) that are maintained in the cloud and used by the IVI system 905. Cloud-based service 950 also includes a content and services proxy module 960, an application management module 965, and a utilities module 970.

The utilities library 915 is a set of common utilities/libraries that applications can utilize. For example, an audio capture client (for capturing microphone audio for off-board voice recognition) and audio decoders (for decoding various encoded audio schemes). The utilities library is not directly accessed by the applications (the IVI bridge 930 is the interface that the applications use), but the underlying functions may not work properly if the proper library functions are not present. The architectural concept here is that over-the-air methods may exist in the platform (in the form of SOTA (software over the air) or FOTA (firmware over the air)) that can update those libraries so that the loaded applications will run properly. For example, if an application uses a particular version of audio decoder, but the device does not yet have that version of the audio decoder installed, when that application is sent to the device, the system will also check for the presence of the proper libraries. If the proper libraries are not there, they will be installed/updated as a part of the application installation process.

The application manager 920 has the primary function of ensuring that the proper loading of device-side application code takes place. The application manager 920 also ensures that the applications themselves are properly tracked and managed within the IVI system.

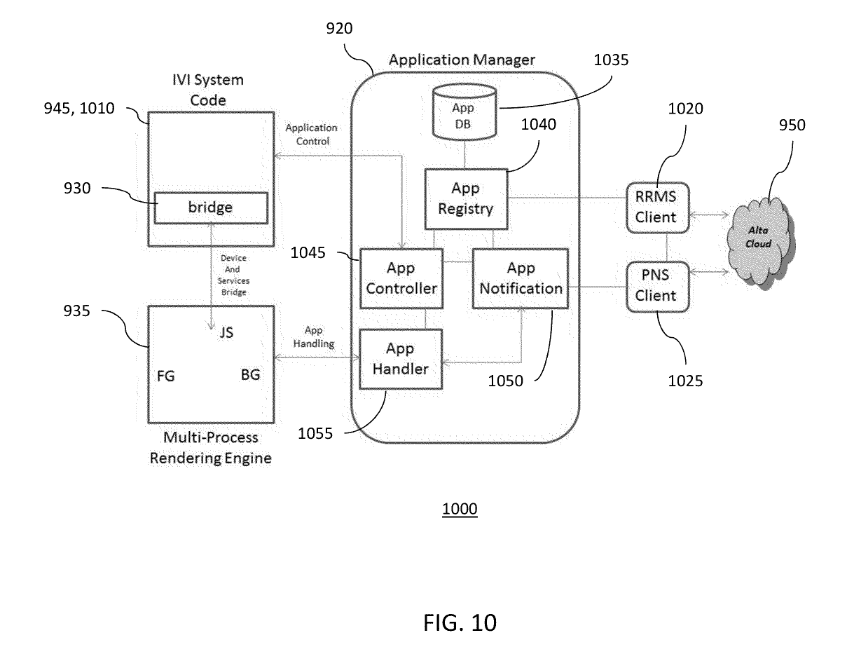

FIG. 10 is an exemplary embodiment of a system 1000 for providing cloud-based applications and further describing an embodiment of the application manager 920. The application manager 920 handles all applications running on the system. The application manager 920 is responsible for supporting communication between services and applications.

With respect to monitoring and/or managing applications, the application manager 920 is responsible for determining or monitoring a status of the running applications, e.g., foreground (FG) or background (BG). The application manager 920 is responsible for the arrangement of applications on the HMI, e.g., foreground or background.

The application manager 920 is also responsible for management of application transition. Application transition management may entail, for example: non-active to active (FG) transition; active (FG) to active (BG) transition; active (BG) to active (FG) transition; active (BG) to non-active transition; active (FG) to non-active transition; and the reloading of an application.

With respect to supporting communication, the application manager 920 is responsible for supporting requests from applications and/or services. The application manager 920 is also responsible for supporting application to application messaging. The application manager 920 is further responsible for supporting application to service messaging.

The application manager 920 is broken up into functional components in FIG. 10. This component breakdown is the logical recommended/reference implementation. However, because the application manager 920 may be a monolithic software module, it is not absolutely necessary to break the code architecture into these exact blocks. The functions described in the functional components view must be present and operating for a conformant application manager design regardless of implementation approach.

The App Registry 1040 interfaces with the required recoverable resource management services (RRMS) Client 1020 to add/modify/delete applications as instructed by the Alta cloud 950. The App Registry 1040 function interfaces with the App Database 1035 to have the proper applications stored and available. The App Registry 1040 function also provides the master list of applications and attributes (metadata, application parameters (autostart, etc), application identifier (ID), etc.) associated with those applications. Other examples of application parameters include users allowed to use the application (for use cases that allow for multiple users/drivers) and any on-board (IVI or mobile device) resource access credentials. One example of on-board resource access credentials includes whether or not an application is allowed to access vehicle information, e.g., speed, odometer, on-board diagnostics (OBD) information, and/or other telematics information. The App Controller 1045 and App Notification 1050 functions use the App Registry 1040 master list for various operations as detailed below.

The App Controller 1045 is the functional heart of the Application Manager. The App Controller 1045 has the ability (based upon a variety of inputs, including IVI System Code 1010 (e.g., IVI System Framework 945) to start/stop applications, to reload an application, and to set an application as foreground/background, for example. In addition, the App Controller 1045 keeps track of a current status of all applications, receives application monitoring data, and, if necessary, takes action based upon that monitoring data. The interface with the WI System Code 1010 also needs to communicate with the App Controller 1045 for app-to-app communication as needed.

The App Handler 1055 interfaces directly with the Rendering Engine 935 to load and operate the apps. The App Handler 1055 effectively executes the manipulation the App Manager 920 is instructing (e.g., set to foreground, set to background, start, stop, reload).

Service notifications from the Alta Cloud 950 come into the device through the Push Notification Client 1025. The device may be IVI system 905 or, as described below, device 1225, 1245. The App Notification 1050 function identifies valid application-specific notifications and passes these notifications to the App Controller 1045, which then communicates the notification information to the application through the Device and Services Bridge 930.

The IVI System Code 1010 is effectively the primary Tier-1 code of the unit 905, 1225, 1245. This code may be native, hypertext markup language (html), or a combination of native and html.

Although FIG. 10 shows Multi-Process Rendering Engine 935 as a separate element, in one exemplary embodiment, the Multi-Process Rendering Engine 935 is instantiated within the IVI System Code 1010. The IVI System Code 1010 provides a Device and Services Bridge 930 that allows the applications to communicate with the overall system via a JavaScript Bridge (JS).

Applications are designed to communicate with the overall system through the Device and Services Bridge 930. This Device and Services Bridge 930 enables app developers to work with a single interface. This single interface can be used by app developers to provide a variety of functions including, but not limited to, monitoring pings, providing app-to-app communications (including start app, etc.), and carrying out pertinent user interface (UI) events (home button push, for example). In one example of app-to-app communication, a location-based app, e.g., local search, identifies a POI and sends that POI to another app, e.g., a navigation app, to provide the route. In another example of app-to-app communication, a navigation app crosses through a geo-fence that triggers a different app to pull up new information on-screen, e.g., a coupon display app for a local coupon.

The IVI Bridge 930 is a JavaScript bridge that enables all applications to obtain access to the various required aspects of the IVI system 905. The types of data accessed/shared and the methods thereof are generic (except for the requirement to be JavaScript-based at the application side). The key is that the application developer only needs a Common IVI Bridge Definition File (e.g., get GPS, send POI to Nav, etc.), and no further information is needed for the developer. Each IVI System 905 is then designed with an IVI Bridge 930 that conforms to the Common WI Bridge Definition File, and then the Common Application will run on all past, present, and future IVI Systems that conform to the Common IVI Bridge Definition File.

The Rendering Engine 935 is the HTML5 ‘browser’ that exists on the IVI system 905. Applications get loaded into the Rendering Engine 935 and run within that environment. Because HTML5 Browsers execute code completely independent of the type of hardware and/or operating system, the cross-platform benefit is achieved.

The Connection Manager 940 provides the required IP connection for each application. Based upon parameters from the cloud (IP connections allowed/preferred) and real-time and quasi-real-time data available on-board (quality of service data, for example), the appropriate IP connection is offered to the application. IP connection options may be on-board modem, connected smartphone/tablet, external WIFI hotspot, V2I/V2V (vehicle to infrastructure/vehicle to vehicle) connection, etc.

The Application Container 955 stores, manages, and organizes all actual applications. Applications are comprised of the actual application code/objects and any associated application metadata that may be required. Each application in most cases has a unique application identifier. For each unique application, there may be on-device application code and/or off-board application code. Regardless of ultimate storage location, the Application Container 955 holds the associated application code objects and manages the actual deployment of such objects.

The Content and Services Proxy Module 960 provides the cloud-resident content and services that are utilized/consumed by the applications. The Content and Services Proxy Module 960 also provides the proper security for applications to connect (which can take many forms depending upon platform implementation requirements for security). Examples include (but are not limited to) content proxy to all content types (including third-party remote content), cloud-based white listing (if necessary), and application-specific services. In addition, the application-specific services may be developed directly on the Content and Services Proxy Module by the application developer (using direct code or graphical pipeline editors).

The Application Management Module 965 performs the customer-specific management and deployment of the applications. From an enterprise view, the Application Management Module 965 enables an Administrator Function to associate applications with particular devices and groups. Beyond the Administrator Function, the Application Management Module 965 also enables an end-user application store front (in the form of a website, etc.) to enable the end-user to choose, manage, and buy applications. As such, the Application Management Module also issues application deployment commands that are then executed by a specific service implemented on the Content and Services Proxy Module 960 in conjunction with the Application Container Module 955.

The Utilities Module 970 represents a plurality of possible back-end processes and functions that may be needed to implement the platform. In most cases, these are Customer Relationship Management (CRM) functions that enable CRM systems to work with the platform to deliver content and services to individual entities. This includes device provisioning, individual enrollment, and sharing of CRM data to enable proper delivery of services to individuals (based upon customer profile and settings, etc.).

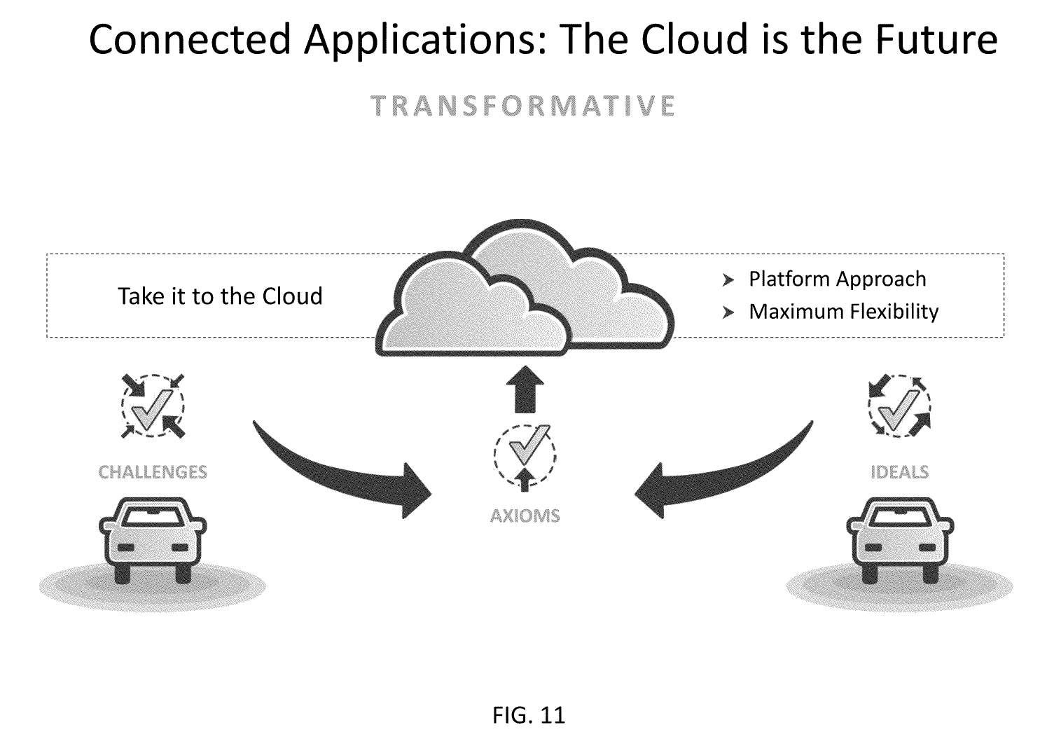

FIG. 11 is a diagram illustrating matching challenges and ideals with axioms for providing cloud-based services.

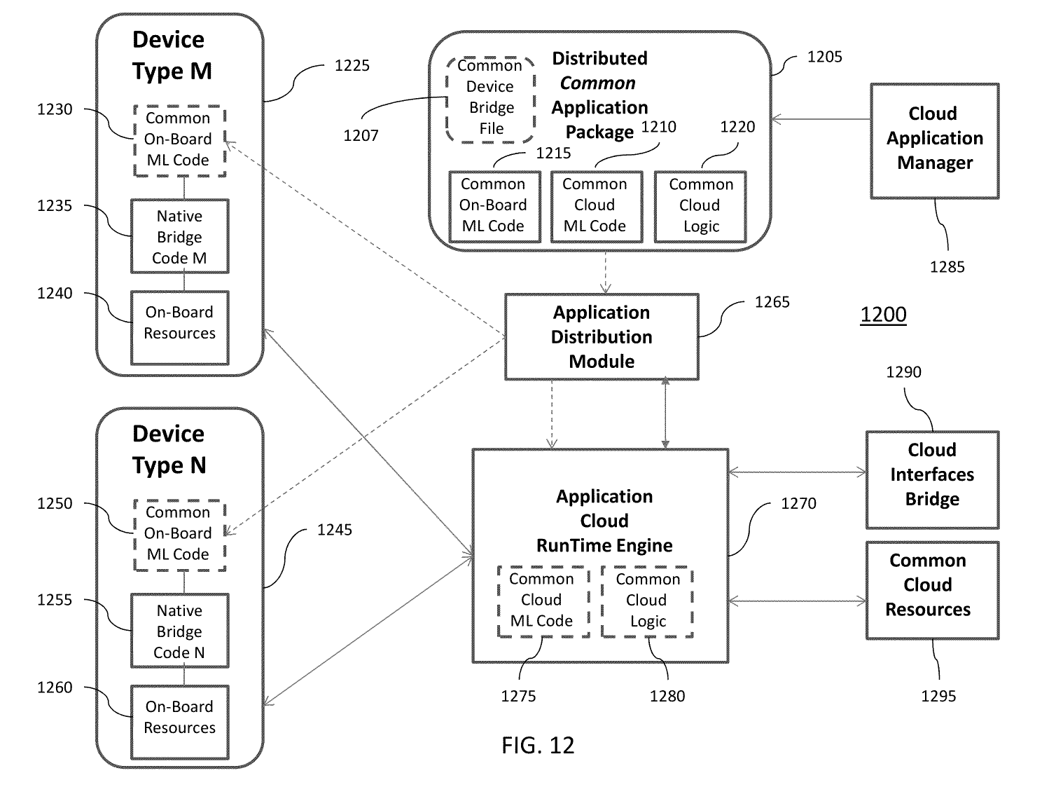

FIG. 12 is an exemplary embodiment of a block diagram of processes and systems for providing cloud-based applications. System 1200 includes one or more devices 1225, 1245, which may be of different types, e.g., Type M and Type N as shown in the figure, and capable of having different device parameters. Example types for M and N can include, for example, smartphones (such as iPhone® and Galaxy®) and tablets (such as iPad®). Cloud Application Manager 1285 operates within Operation Management 965 and manages a Distributed Common Application Package 1205 that is distributed using Application Distribution Module 1265. The Application Distribution Module 1265 identifies which unique applications need to go where (at the device and cloud level) and sends a manifest deployment request into a specific service for performing the deployment within the Content and Services Proxy Module 960. The Application Distribution Module 1265 also operates within Operation Management 965.

Application Cloud RunTime Engine 1270 uses Common Cloud Markup Language (ML) code 1275 and Common Cloud Logic 1280, and interfaces with the Application Distribution Module 1265, the Cloud Interfaces Bridge 1290, and Common Cloud Resources 1295 in order to execute cloud-based applications on the various devices 1225, 1245. In one exemplary embodiment, Cloud Interfaces Bridge 1290 and Common Cloud Resources 1295 provide the actual applications.

Cloud Interfaces Bridge 1290 is provided within Content and Services Proxy 960 and may interface to external content and services. Common Cloud Resources 1295 is provided within Content and Services Proxy 960 and may interface to external content and services. Application Cloud RunTime Engine 1270 operates within Content and Services Proxy 960.

The Common Cloud ML code 1275 is the actual application code for a particular application. The components in this case are in the cloud, not on the device(s). The Common Cloud Logic 1280 is any potential application-specific service logic that is ultimately loaded and run in the cloud. Common Cloud Logic 1280 is not ML code.

Predominantly, the system enables a Common Application Package 1205 to be updated in the cloud. This Common Application Package 1205 is comprised of three primary elements: Common Cloud ML (Mark-up Language) Application Code 1210; Common On-Board ML Application Code 1215; and Common Cloud Logic Application Code 1220. The distributed Common Application Package 1205 is contained in Application Container 955. In one exemplary embodiment, Common Cloud Logic can be loaded directly into a database (not shown) associated with Content and Services Proxy Module 960 through a separate process.

The Common Application Package 1205 can include one or more of these elements 1210, 1215, 1220 in any combination. What is referred to as a distributed application approach enables an application developer to access and change any of these three elements 1210, 1215, 1220 for optimum performance for the particular application, as opposed to a monolithic application approach.

In most current competitive systems, the application developer is constrained to developing application code within the application that is loaded onto the device. However, having some actual application code in the cloud is useful. For example, no updating of devices is ever required for this code whatsoever—it is in the cloud and loads into the rendering engine. The present system/platform provides the ability for current and/or future technologies to make the code running in the cloud more efficient and capable. In one exemplary embodiment, application developers create their own customized content and services in the cloud (e.g., customization of the content/service Application Programming Interface (API) for optimum utilization by the actual application code).

When the Common Application Package 1205 is deployed and/or changed in the cloud, it can be distributed over-the-air to the various elements so that the Common Application Package 1205 installs and runs on any target device, e.g., device 1225, 1245, independent of the device's particular individual parameters (e.g., operating system (OS), processor type, on-board resources, and interfaces). Common On-Board ML Code 1230, 1250 is the application code, e.g., device side application code, stored in Application Manager 920.

In one embodiment, a Common Application Package 1205 is a package for a particular unique application. Within that Common Application Package, personalization functionality, e.g., by customer, is provided as well as separate functionality for the application as a whole. The application line-up for a particular customer (which is a plurality of Common Application Packages) is customizable by the customer through an application storefront, which is supported within the Application Management Module 965.

Dependence on the OS and the processor is substantially eliminated through the application of Markup Language (ML) and Web-based technologies (HTML, cascading style sheets (CSS), and JavaScript are current modern examples). The benefit of ML and Web-based technologies is that these are common methods by which applications can be run on a variety of platforms. The app is not “native” to the operating system in any way unlike, for example, applications developed for a particular operating system like Apple iOS® or Android® based applications. The app runs in a browser or rendering engine that is installed on most systems, and is installed on top of the operating system and processor.

The On-Board Resources and Interfaces dependencies are substantially eliminated through a device bridge concept. The application developer designs according to a Common (Device) Bridge Definition (File) 1207. A common bridge definition file defines the common ways that an application is expecting to communicate with the device once loaded onto the browser. For example, there will be a common call/interface to get GPS information, or to deliver audio to the speakers, etc. In this case “common” refers to the calls/interfaces being common from one hardware implementation to the next, so the application that is designed using the common bridge definition will work on any piece of hardware (past, present, or future) that is designed to offer the common bridge functionality.

On each device, a Native Bridge Code Module 1235, 1255 is created that translates the specific access to resources 1240, 1260 on-board to the Common Device Bridge Definition 1207, which the Common Application Package 1205 can then consume. Native Bridge Code Module 1235, 1255 corresponds to IVI Bridge 930. On-board resources 1240, 1260 are contained in IVI System Framework 945.

This approach effectively allows one Common Application Package 1205 to be incrementally updated (no complete re-compile necessary) and then be deployed to all device variants 1225, 1245, with the resulting efficiency of multiple code developments, multiple complete application validation cycles, and/or reduced validation cycles (as opposed to having to re-validate the entire system, the entire set of applications, and/or the entire set of devices), becoming a reality.

In addition, the processes and systems described set up common interfaces for content and resources.

Through this methodology, if the external content interfaces required for any application are changed, the Cloud Interfaces Bridge 1290 can be changed in the cloud, so functionality can be maintained and assured without a change to the Common Application Package 1205. Examples of external content interfaces can include streaming services, point-of-interest databases, social networking, and texting.

In one exemplary embodiment, Cloud Interfaces Bridge 1290 is a content API that sits on the Content and Services Proxy 960. For example, the Cloud Interfaces Bridge 1290 may have a defined weather interface, and the weather interface to a particular provider may change (or be forecasted to change). The Cloud Interfaces Bridge code can be changed and loaded onto the system in real time (e.g., by hot swap) such that the provider's API change has no impact whatsoever on the functionality of the unit/device 905, 1225, 1245.

In addition, all Common Application Packages 1205 have a common set of Common Cloud Resources 1295 available to create the distributed applications. This provides developmental efficiency (common environment) and also enables changes in the Common Cloud Resources 1295 without having to change the Common Application Package 1205 in any way. Examples of Common Cloud Resources 1295 include voice recognition, situation-aware messaging engines, device state and presence engine, Customer Relationship Management (CRM), billing, and mobile couponing.

At the device side, the common runtime and application environment is ensured by a basic application framework in place on the device. The application framework is also over-the-air updateable through the cloud. In one exemplary embodiment, the device manufacturer implements the device-side code that connects to the Alta cloud, e.g., cloud-based service 950, in conformance to the offered SDK 910.

Different embodiments of the invention may be implemented using different combinations of software, firmware, and/or hardware. Thus, the techniques shown in the figures, e.g., FIGS. 1 to 12, can be implemented using code and data stored and executed on one or more electronic devices (e.g., onboard equipment, an end station, a network element, a cloud-based server, a mobile device). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The phrase “at least one of A and B” is used herein and/or in the following claims, where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for providing cloud-based common distribution applications, which comprises:
one or more devices, each device capable of being a different device type and having different parameters;
a distributed common application package for at least one of deployment and updating in the cloud such that the common application package installs and runs on any of the one or more devices independent of parameters of any of the devices, the distributed common application package comprising at least one of:
common cloud mark-up language (ML) application code;
common on-board ML application code; and
common cloud logic application code;
an application distribution module; and
an application cloud runtime engine that is used to execute at least one application on the one or more devices.

2. The system according to claim 1, further comprising a cloud application manager that manages the distributed common application package.

3. The system according to claim 1, wherein the application distribution module identifies where applications need to go and sends a manifest deployment request into a specific service for performing a deployment.

4. The system according to claim 1, wherein the application cloud runtime engine uses common cloud markup language (ML) code and common cloud logic.

5. The system according to claim 4, wherein the common cloud ML code comprises actual application code for a particular application.

6. The system according to claim 4, wherein the common cloud logic is application-specific service logic that is loaded and run in the cloud.

7. The system according to claim 1, wherein personalization by customer is provided within the common application package.

8. The system according to claim 1, wherein an application line-up comprises a plurality of common application packages.

9. The system according to claim 8, wherein the application line-up is customizable by customer.

10. The system according to claim 1, wherein dependence on an operating system and a processor is substantially eliminated using markup language and web-based technologies.

11. The system according to claim 10, wherein the at least one application:
runs in a browser or rendering engine;
is installed on top of the operating system and the processor; and
is non-native to the operating system.

12. The system according to claim 10, wherein the web-based technologies include at least one of hypertext markup language, cascading style sheets, and JavaScript.

13. The system according to claim 1, wherein the common application package further comprises a common bridge definition file, the common bridge file defining common ways that the at least one application is expecting to communicate with the one or more devices.

14. The system according to claim 13, wherein the one or more devices comprises a native bridge code module that translates specific access to resources to the common bridge definition.

15. The system according to claim 1, wherein the common application package is incrementally updated without requiring a complete re-compile.

16. The system according to claim 1, further comprising a cloud interfaces bridge and common cloud resources, the cloud interfaces bridge and the common cloud resources interfacing with the application cloud runtime engine to execute the at least one application.

17. The system according to claim 16, wherein at least one of the cloud interfaces bridge and the common cloud resources interfaces to external content and services.

18. The system according to claim 1, wherein one or more of the common cloud ML application code, the common on-board ML application code, and the common cloud logic application code are accessed and changed.

19. The system according to claim 1, wherein the common on-board ML application code comprises device side application code.

20. The system according to claim 1, wherein the common application package is distributed over the air.
